(19) United States
(12) Patent Application Publication
(10) Pub. No.: US 2004/0126893 A1
(43) Pub. Date: Jul. 1, 2004

(54) Method for detecting tse-induced modifications in the human and animal body

(76) Inventors: Dieter Naumann, Berlin (DE); Michael Beekes, Falkensee (DE); Jurgen Schmitt, Gusterath (DE); Thomas Udelhoven, Trier (DE); Angelika Brauer, Berlin (DE)

Correspondence Address: FOLEY AND LARDNER, SUITE 500, 3000 K STREET NW, WASHINGTON, DC, 20007, US

(21) Appl. No.: 10/468,012

(22) PCT Filed: Jan. 17, 2002
(86) PCT No.: PCT/DE02/00210

(30) Foreign Application Priority Data
Feb. 22, 2001 (DE) 101 09 901.0

(51) Int. Cl. G01N 21/62

(52) U.S. Cl. 436/171

(57) ABSTRACT

The invention relates to a method for detecting transmissible transmissible spongiform encephalopathies (TSE) in the human and animal body, wherein body fluid is taken in vivo from the individual to be examined and exposed to infrared radiation. At least one characteristic spectral pattern is selected from the current infrared spectrum. Said TSE-specific spectral areas are compared to characteristic spectral patterns of infrared spectrums which are stored in a reference data bank and which are produced from body fluids of individuals known to be infected or not infected by TSE.

The invention relates to a method for detecting pathological changes in the human and animal body which are induced by transmissible spongiform encephal-opathies (TSEs).

Transmissible spongiform encephalopathies are transmissible neurodegenerative diseases of the central nervous system (CNS) having a fatal outcome. The disease affects both mammals and humans. TSE serves as a generic term for designating a complex of transmissible encephalopathies occurring in a variety of species. In animals, these diseases more specifically include bovine spongiform encephalopathy in cattle (BSE), scrapie (trotting disease) in sheep, goats, hamsters and mice, chronic wasting (CWD) in certain American deer species, transmissible encephalopathy in mink (TME), feline spongiform encephalopathy (FSE) in cats and a spongiform encephalopathy in antelopes. Four types of TSE are distinguished in humans: Creutzfeldt-Jakob disease (CJD), Gerstman-Stassler-Scheinker syndrome (GSS), fatal familial insomnia (FFI) and kuru.

In the case of economically useful animals, diagnosis is of great interest because of potential transmission as a result of consuming the meat and blood of diseased animals. Thus, it is suspected, for example, that consuming BSE-contaminated beef can give rise in humans to a new variant of CJD (nvCJD). With the aim of protecting the consumer and stemming the epidemic, some states therefore implement official surveillance of the degree of contamination of the cattle stock with BSE.

To this end, routine inspections of slaughtered cattle are arranged in abattoirs, with the subsequent use of the slaughtered meat depending on the results of these inspections.

To date, it has only been possible to diagnose TSE with certainty post-mortem by a) histologically detecting characteristic spongiform (sponge-like) changes in the brain tissue, b) immunologically detecting deposits of the pathological prion protein (PrP) by means of immunoblotting (Western blotting technique and histoblotting technique) and immunohistochemistry, c) electonmicroscopically detecting scrapie-associated (PrP) fibrils (SAFs) and d) detecting the infectious TSE agent by means of transmission experiments in animals.

Up until now, two diagnostic methods have become available for identifying TSE-infected farm animals on a large scale, i.e. “Prionics Check”, supplied by the Swiss company Prionics AG, and a test developed by BIQ-RAD (“Platelia BSE”). Both methods are post-mortem tests which use tissue from the brain stem and which are restricted to use in the abattoir. According to information supplied by the manufacturer, the Prionics test makes it possible to diagnose BSE in cattle up to six months before clinical symptoms appear (information supplied by the manufacturer on the Internet: www.prionics.com). In the method developed by Prionics, a tissue sample is removed from the medulla oblongata of slaughtered cattle, homogenized and treated with the enzyme proteinase K. Any pathological prion protein which may remain after treatment is labeled with the monoclonal antibody 6H4 (prepared by Prionics AG) and then stained in a Western blot. In the Platelia test, a brain stem sample is homogenized and treated with proteinase K. The pathological prion protein is then concentrated by precipitation, bound by a monoclonal antibody in a capture ELISA and then labeled and stained using a second monoclonal antibody.

The disadvantages of these methods consist in the method itself being in each case very elaborate, with technical experts, some of whom are highly specialized, being required for removing, preparing and analyzing the samples, and in their duration, of approx. 5 (BIO-RAD test) and up to 8 (Prionics test) hours, which, according to information supplied by the manufacturers, is the time taken from the time the sample is removed until the result is obtained. Another disadvantage of the post-mortem diagnosis arises from the fact that, because of the procedure employed, infected cattle are only identified after they have been at least partially dismembered in the abattoir. For this reason, post-mortem diagnosis is not able to effectively prevent accidental contamination and infection in the abattoir. Such prevention would be much more satisfactorily ensured if infected cattle could be identified ante-mortem, without opening the body, and then disposed of harmlessly.

At present, a variety of test systems are under development for enabling large numbers of samples of different tissues and body fluids to be screened sensitively and rapidly ante-mortem and post-mortem for pathological prion proteins, thereby making it possible to diagnose TSE on a large scale. These test systems also include, inter alia, an unevaluated capillary electrophoresis immunoassay using fluorescent-labeled peptides (Schmerr & Jenny: Elektrophoresis 19, (1998) 409-419; Schmerr et al.: Journal of Chromatography A 853, (1999)207-214) and an immunoassay using fluorimetrically detected, europium-labeled antibodies (DEFFIA, from Wallac, Turku, Finland; Safar et al.: Nature Medicine 4, (1998) 1157-1165).

Clinical symptoms and detection, in the chemical laboratory, of elevated concentrations of particular proteins in the spinal fluid and/or serum [protein 14-3-3 (Zerr et al. (1997) N. Engl. J. Med. 336:874, Zerr et al. (1998), Ann. Neurol. 43: 572-573); protein S100 (Otto et al. (1997) J. Neurol. 244: 566-570, Otto et al. (1998) Brit. Med. J. 316: 577-582; Otto et al. (1998) J. Neurovirol. 4: 572-573) and neuron-specific enolase (Zerr et al. (1995) Lancet 345: 1609-1610)] only enable a tentative diagnosis to be made in humans and animals. The same applies to the altered results which are seen in EEG tomographic and magnetic-resonance tomographic investigations in connection with human TSE diseases. As far as diagnosing BSE in cattle is concerned, the known investigative methods using tissue samples, which methods can be carried out post-mortem and with a high degree of input, also suffer from the crucial disadvantage that the tissue can only be examined after the animals concerned have been slaughtered. This means that it has thus far not been possible to screen living herds or to carry out examinations, which start at an early stage and which can be repeated at intervals, on the living subject.

Finally, DE 199 23 811 C1 has already disclosed a method for rapidly identifying transmissible spongiform encephalopathy-induced pathological changes in animal or human tissues using infrared spectroscopy, in which infrared radiation is directed onto a tissue sample which has been altered pathologically by TSE and the spectral characteristics of the infrared beams are recorded, following interaction with the tissue sample, and the resulting infrared spectra are compared with a reference database, which contains infrared spectra from TSE-infected and uninfected tissues, and then classified.

This method, which can readily be automated, which requires little in the way of personnel and equipment and which can be implemented without highly specialized experts, is diagnostically highly sensitive and, in a very short time, provides reliable results which are free from erroneous human assessments. However, it is disadvantageous insofar as its use is restricted to pathologically damaged tissue, in particular tissue samples from the central nervous system in which detectable pathological changes are also to be expected. Such tissue material can only be removed “post-mortem”, e.g. in the abattoir in the case of slaughtered animals which are earmarked for consumption. It is not possible to use this method to carry out examinations, which can be initiated at an early stage and repeated at intervals, on living animals, with these animals then being culled in a timely manner if an infection is diagnosed. Furthermore, “post-mortem” diagnosis in an abattoir, where the infected animals are only identified after having been dismembered, entails the risk of contamination and infection.

The invention is therefore based on the object of specifying a method for detecting TSE-induced changes in the human and animal body, which method makes it possible, with little input, to rapidly and reliably detect TSE infections within the context of carrying out examinations, which start at an early stage and which can be repeated, on living individuals.

According to the invention, the object is achieved using a method having the features contained in patent claim 1.

The fundamental inventive concept consists in the proposal to detect TSE infection IR-spectroscopically in body fluids which can be withdrawn from the living individual, for example in the form of blood, but which do not manifest any lesions which are characteristic of the disease and which do not exhibit any other known pathological impairments either. In other words, the essence of the invention lies in the detection, for the first time and using IR spectroscopy, of molecular changes, which are due to TSE but which the scientific community did not expect in this location, in body fluids, or their fractions, which can be withdrawn ante-mortem, and in the fact that such a proposal has not previously been made despite the outstanding advantages and the urgent need which has now existed for a long time.

According to the invention, infrared spectra of body fluid samples which have been taken ante-mortem from both TSE-infected individuals and healthy individuals are first of all prepared, after which regions possessing characteristic wavelengths or spectral features are selected and a corresponding reference database is set up. The detection of TSE in the individuals to be investigated is now carried out using the body fluid samples or body fluid fractions which have been removed from these individuals ante-mortem, and using the infrared spectra which have been produced from these samples or fractions, or the spectra in at least one selected characteristic spectral region, such that the selected characteristic spectral regions of the samples in question are compared with the corresponding characteristic spectral regions of the reference samples for both healthy and diseased individuals. It is possible to reliably establish whether the body fluid being investigated is derived from a healthy individual or a TSE-diseased individual both from the difference and from the agreement between the characteristic features of the reference spectra for diseased and healthy individuals and the characteristic features of the investigative spectra in question. A two-fold reliability in assessing the sample spectrum in question is achieved by comparing the sample spectrum in question with the reference spectra from both healthy and TSE-diseased individuals. It goes without saying that the reference spectra and the sample spectra in question are constructed under identical conditions as regards sample withdrawal, sample preparation and the generation of the spectra and selection of the characteristic spectral regions. That is, all the parameters for the reference measurement and the sample measurement have to be selected such that they are identical.

The advantages of the invention lie, in particular, in the fact that it is possible to use a sample, which is provided in vivo by means of a small intervention, to obtain highly reliable proof of the presence of a TSE infection in less than a minute. This also makes it possible to improve the differential diagnosis of human TSE diseases. The high degree of reliability of the investigative result is due, in particular, to the spectra being evaluated or compared using mathematical criteria exclusively, and to subjective, and erroneous, human judgements being ruled out. The TSE detection, which is carried out in vivo, furthermore potentially offers the possibility, when treating TSE and when developing drugs, of testing the efficacy of the drugs by means of rapidly monitoring the course of the disease in an uncomplicated manner. The method according to the invention can also be used, with little input and with a high degree of reliability, to examine blood donors, organ donors and tissue donors for the presence of TSE. Particular importance must be attached to the proposed method both when determining the causes of BSE in farm animals and in association with consumer protection, since it is now possible to examine the entire stock of farm animals on a continuous basis. Substantial advantages as compared with the known methods are also to be seen in the decrease in time and equipment input due to the immediacy of the IR-spectroscopic examination of the body fluids or fluid fractions, which are exposed to the infrared radiation as an infrared-transparent dry or liquid film.

Additional features, and advantageous further developments of the invention, ensue from the subclaims and from testing the proposed method, with the testing being explained below by way of example.

The sample material employed is preferably blood and blood fractions, in particular blood serum.

For the purpose of displaying characteristic, distinguishable patterns in the infrared spectra which are produced, use is made of wavelength selection and an algorithm for “feature selection” in order to clearly visualize the small spectral differences between infected and uninfected sample material.

According to another feature of the invention, multicuvettes are used for measuring several samples. In addition, it is possible to use microspectrometric techniques or sample carriers which are used in the case of microtitration plates. Suitable sample carriers are cuvettes made of water-insoluble optical materials or else scored metal plates, metal gratings or flow-through cuvettes. It is also possible to conceive of using infrared light conductors. Automated sample preparation and measurement, and a high sample throughput, are consequently possible when the quantity of sample is small.

In a further development of the invention, the infrared spectrum of the prepared samples is recorded in the mid infrared range between 500 and 4 000 cm⁻¹ and/or in the near infrared range between 4 000 and 10 000 cm⁻¹.

According to another feature of the invention, characteristic spectral regions are selected, for optimally distinguishing the spectra for the analysis, either visually or by using multivariate methods for selecting spectral features. In this connection, covariance analysis or simple univariate variance analysis has, for example, proved to be of value for finding suitable spectral regions. However, other methods, such as wavelength selection using genetic algorithms, and combining this with a statistical criterion, for example a discriminance method or a statistical distance measurement, are also suitable for this purpose.

According to another feature of the invention, the spectra are subjected to a preliminary processing, independently of the choice of the method for wavelength selection, with this preliminary processing having proved to be advantageous. Methods which are suitable for doing this are calculating the first or second derivative, spectral deconvolution or other methods for increasing the spectral contrast which simplify band recognition or the minimization of any base line problems. Data reduction or transformation, for example by means of wavelet transformation or factorization by means of principal component analysis, or other methods of multivariate statistics, also offer the possibility of achieving preliminary data reduction and an improvement in the subsequent classification into infected and uninfected animals.

In another development of the invention, after characteristic spectral regions have been selected, and after methods for increasing the spectral contrast and for data reduction have been used for subjecting the spectra to a preliminary processing, statistical methods for pattern recognition, artificial neural networks, methods of case-based classification or machine learning, or genetic algorithms or evolutionary programming are used for classifying the characteristic spectral regions for the purpose of establishing differences between the reference spectra and the sample spectra in question. Preference is given to using an artificial neural network, as a feedforward net having three layers, and a gradient descent method, as a learning algorithm, for the classification.

An experimental run which was carried out in conjunction with the method according to the invention is described below:

Adult male and female Syrian hamsters (Mesocricetus auratus) were infected with the scrapie strain 263 K. In this connection, 27 animals were infected intracerebrally (i.c.), 90 animals were infected intraperitoneally (i.p.) and 29 animals were infected perorally (p.o.). The number of uninfected control animals was 113. 22 animals were mock-infected i.p. while 31 animals were mock-infected p.o. The hamsters in the i.c. series were given 50 μl of inoculum containing differing quantities of infectious 263 K agent. The i.p. series and the p.o. series were infected with 100 μl of a 10% suspension of 263 K scrapie brain homogenate containing a dose of 1-3*10⁷ LD₅₀ i.c., as described in Baldauf et al. (1997, J. Gen. Virol. 78, 1187-1197). The control animals were either given brain homogenate from uninfected donors i.p. or p.o. or remained completely without treatment. At the time of administration of the inoculum, all the recipients were 4-6 weeks old. The incubation time for the i.c.-infected animals was from 83 to 210 days. The i.p.-infected and p.o.-infected hamsters had mean incubation times of 118+12 (SD) and 157±9 (SD) days. All the animals were euthanized with CO₂ in the terminal stage of the scrapie infection. The i.p. mock-infected, the p.o. mock-infected and the uninfected animals were sacrificed at ages of 140-180, 170-210 and 30-140 days, respectively. Blood was withdrawn and serum was isolated as described in Otto et al. (1998, J. Neurovirol. 4: 572-573).

For the analyses, in each case 2.6 μl of the blood serum were transferred to a ZnSe multisample cuvette, air-dehydrated and dried, at 37° C. for 5 minutes, to a transparent film in a drying oven. After that, the preparation of the sample had been concluded and the measuring cuvette was transferred to an FT-IR spectrometer (IFS 28/B, Bruker Optik GmbH, Germany) and the FT-IR spectra of the samples were recorded. The spectra were recorded in the wave number region of 4 000-500 cm⁻¹, at a nominal physical resolution of 4 cm⁻¹, using a deuterated triglycine sulfate detector (DTGS). A Blackmann-Harris 3-term function and a zerofilling factor of 4 were used as the apodization function for the Fourier transformation. 128 scans were recorded and averaged. All the samples were in each case measured 3 times, where appropriate on different occasions.

For the subsequent analysis of data, the second derivatives of the absorption spectra were obtained using a Savitzky-Golay smoothing of 9 data points and a subsequent vector normalization in the range of 2 820-2 985 cm⁻¹. As a result, the data had comparable value ranges.

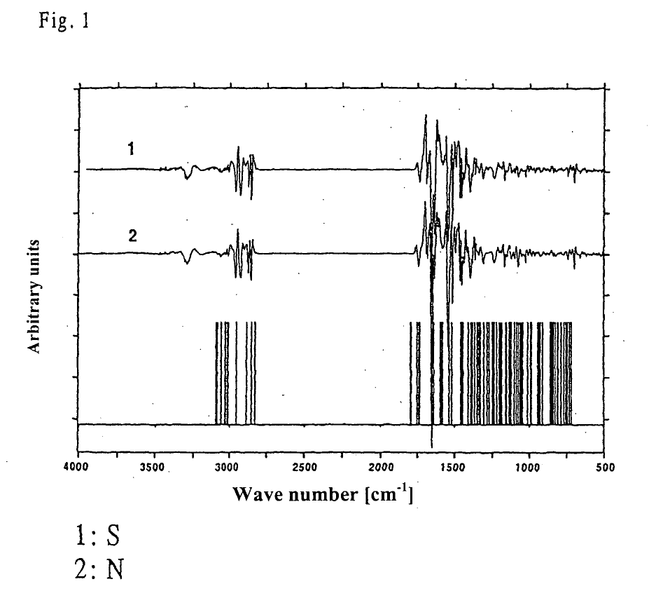

The measurements were subdivided into three independent data sets: a training data set, a validation data set and a test data set. The training data set contained 89 samples with 267 spectra, while the validation set contained 39 samples with 117 spectra and a test data set with 184 samples and 522 spectra (see table 1). The 4 000-500 cm⁻¹ FT-IR spectrum which was recorded was characterized by a high proportion of redundant information. For this reason, an algorithm for “feature selection” was used in order to improve the classification model. This thereby decreases the complexity and dimensionality of the classification model and it is now only the relevant spectral information which is used. This made it possible to substantially improve the quality and robustness of the analytical system. To do this, the data points were first of all reduced by forming an average over 3 points; after that, the covariance was calculated, by way of the partial F value for the 2 classes (“infected” and “uninfected” sera) in the spectral windows of 700-1 500 cm⁻¹, 1 700-1 750 cm⁻¹ and 2 800-3 100 cm⁻¹ using the data points. After that, a ranking with the covariance values in descending order was established and the 89 wavelengths exhibiting the highest values were used for the classification model. The spectral differences which are obtained in the spectra from the infected and uninfected animals following the wavelength selection using a “feature selection” algorithm are shown in FIG. 1. FIG. 1 shows representative second derivatives of the FT-IR spectra obtained with hamster serum from (1) an uninfected control animal and (2) an animal which was infected i.p. with scrapie and which was in the terminal stage. The spectral regions which provide the most important contribution for the classification, after the covariance for the two classes scrapie-infected and uninfected has been calculated, are shown as bars.

A neural network which was constructed using the Synthon NeuroDeveloper (Synthon, Gusterath) was used as the classification model. This network was a feedforward net having 3 layers: an input layer, a hidden layer and an output layer. The input layer possessed 89 neurons (units), while the hidden layer possessed 9 neurons (units) and the output layer possessed 2 neurons (units). The neurons of the output layer were assigned to the class “infected” (S) and “uninfected” (N). The net was completely connected and possessed shortcut connections, i.e. direct connections from the input layer to the output layer. RPROP (resilient backpropagation) was used as the learning method (Riedmiller & Braun 1993, Proc. of the IEEE Intern. Conf. on Neural Networks ICNN San Francisco, 591-598, Schmitt & Udelhoven 2000, In. H.-U. Gremlich & B. Yan, Infrared and Raman spectroscopy of biological materials, Marcel Dekker, New York, 379-420), using an update value of 0.1 and an intercept length of 50. A logistic function was used as the transfer function and the initialization took place in the value range of [−1, +1]. 450 training cycles were calculated.

The results for this analytical model for the classification are given in table 1a and table 1b.

Table 1a: shows the testing and classification of serum samples from intracerebrally (i.c.), intraperitoneally (i.p.) or perorally (p.o.) infected scrapie hamsters using FT-IR spectroscopy and an analysis employing artificial neural networks.

The animal is classified as positive when 2 or 3 spectra are rated as being positive. The animal is classified as being negative when only 1, or no, spectrum was graded as being positive.

Table 1b: shows the testing and classification of serum samples from uninfected, intraperitoneally mock (i.p.m.)-infected or perorally mock (p.o.m.)-infected control hamsters using FT-IR spectroscopy and an analysis employing artificial neural networks.

The animal is classified as being positive when 2 or 3 spectra are graded as being positive. The animal is classified as being negative when only 1, or no, spectrum was graded as being positive.

TABLE 1a

| | Number of samples and classification results | | | | | | | | |
|---|---|---|---|---|---|---|---|---|---|
| | Training run | | | Validation run | | | Test run | | |
| | | Correctly^{a} | | | Correctly^{a} | | | Correctly^{a} | |
| Donor animal | N^{a} | positive | Sensitivity [%] | N^{a} | positive | Sensitivity [%] | N^{a} | positive | Sensitivity [%] |
| i.c. inf | 15 (45) | 15 (45) | 100 (100) | 5 (15) | 5 (14) | 100 (93) | 7 (21) | 7 (21) | 100 (100) |
| i.p. inf | 33 (99) | 33 (99) | 100 (100) | 10 (30) | 10 (30) | 100 (100) | 47 (141) | 45 (135) | 96 (96) |
| p.o. inf | — | — | n.a. | 4 (12) | 4 (11) | 100 (92) | 25 (75) | 25 (74) | 100 (99) |

^{a}First value: number of individual serum samples; second value (in brackets): number of spectra
^{b}The first value refers to individual serum samples; the second value (in brackets) refers to the spectra

TABLE 1b

| | Number of samples and classification results | | | | | | | | |
|---|---|---|---|---|---|---|---|---|---|
| | Training run | | | Validation run | | | Test run | | |
| | | Correctly^{a} | | | Correctly^{a} | | | Correctly^{a} | |
| Donor animal | N^{a} | negative | Specificity^{b} [%] | N^{a} | negative | Specificity^{b} [%] | N^{a} | negative | Specificity^{b} [%] |
| uninf. | 38 (114) | 38 (114) | 100 (100) | 13 (39) | 13 (39) | 100 (100) | 62 (186) | 62 (186) | 100 (100) |
| i.p.m. | 3 (9) | 3 (9) | 100 (100) | 1 (3) | 1 (3) | 100 (100) | 18 (54) | 18 (53) | 100 (98) |
| p.o.m. | — | — | n.a. | 6 (18) | 6 (18) | 100 (100) | 25 (75) | 25 (73) | 100 (97) |

^{a}First value: number of individual serum samples; second value (in brackets): number of spectra
^{b}The first value refers to individual serum samples; the second value (in brackets) refers to the spectra

1. A method for detecting TSE-induced changes in the human and animal body in which infrared spectra of samples which are known to be TSE-infected and samples which are not infected with TSE are produced and characteristic patterns from these spectra are stored in a reference database, and a current infrared spectrum is produced from sample material which is currently to be investigated, and the characteristic spectral pattern of this sample material is compared with the reference database, with the sample material being a body fluid, or a fraction of this fluid, which can be withdrawn from the body concerned ante-mortem and exposed to the infrared radiation as an infrared-transparent dry or liquid film.

2. The method as claimed in claim 1, characterized in that blood or blood fractions is/are used as the sample material.

3. The method as claimed in claim 2, characterized in that blood serum is used as the sample material.

4. The method as claimed in claim 2, characterized in that blood plasma, buffy coat or red blood cells is/are designated as the sample material.

5. The method as claimed in claim 1, characterized in that cerebrospinal fluid or amneotic fluid is designated as the sample material.

6. The method as claimed in claim 1, characterized in that, in order to display characteristic, distinguishable patterns in the infrared spectra, wavelength selection and an algorithm for “feature selection” are used in order to emphasize the small spectral differences between infected sample material and uninfected sample material.

7. The method as claimed in claim 1, characterized in that the infrared irradiation of the samples is carried out using multicuvettes or flowthrough cuvettes, sample carriers which are used for microtitration plates, or else employing microspectrometric techniques.

8. The method as claimed in claim 7, characterized in that water-insoluble optical materials, scored metal plates or metal gratings are used as the sample carrier material.

9. The method as claimed in one of claims 1 to 8, characterized in that the diameters of the sample areas through which radiation passes are between 0.5 and 12 mm or, in the case of microfocusing, between 10 and 500 μm.

10. The method as claimed in one of claims 1 to 9, characterized in that the infrared spectrum of the body fluid samples is measured in the mid infrared range from 500 to 4 000 cm⁻¹ and/or in the near infrared range between 4 000 and 10 000 cm⁻¹.

11. The method as claimed in one of claims 1 to 10, characterized in that the infrared spectrum is generated and measured in an arrangement involving transmission/absorption or attenuated total reflection or direct or diffuse reflection, or else using an IR light conductor technique.

12. The method as claimed in one of claims 1 to 11, characterized in that a preprocessing of the spectra is undertaken by forming the first or second derivative, by means of spectral deconvolution or by other methods for increasing the spectral contrast, or takes place by means of transformation, such as wavelet transformation or transformation into principal components using principal component analysis.

13. The method as claimed in one of claims 1 to 12, characterized in that the TSE-specific, characteristic spectral regions are selected visually or using computer-assisted methods of wavelength selection.

14. The method as claimed in claim 13, characterized in that the characteristic spectral regions are recognized and selected using genetic algorithms, statistical distance measurements, covariance analysis and univariate variance analysis, or using mathematical transformation, or using a combination of genetic algorithms and statistical methods such as discriminance analysis or principal component analysis.

15. The method as claimed in one of claims 1 to 14, characterized in that the classification or comparison of the current infrared spectrum in the selected, characteristic spectral regions with the corresponding reference spectra in the spectral regions is performed using statistical features of pattern recognition or on the basis of neural networks, of machine learning or of algorithms of multivariate statistics.

16. The method as claimed in claim 14, characterized in that the classification is carried out on the basis of an artificial neural network as a feedforward net having three layers and of a gradient descent method as a learning algorithm.
